(19) United States
(12) Patent Application Publication
(10) Pub. No.: US 2022/0038681 A1
(43) Pub. Date: Feb. 3, 2022

(54) VIDEO ENCODING OR DECODING USING BLOCK EXTENSION FOR OVERLAPPED BLOCK MOTION COMPENSATION

(71) Applicant: InterDigital VC Holdings, Inc., Wilmington, DE (US)

(72) Inventors: Franck GALPIN, Cesson-Sevigne (FR); Antoine ROBERT, Cesson-Sevigne (FR); Philippe BORDES, Cesson-Sevigne (FR)

(21) Appl. No.: 17/277,127

(22) PCT Filed: Nov. 1, 2019
(86) PCT No.: PCT/US2019/059415

§ 371 Date: Mar. 17, 2021

(30) Foreign Application Priority Data
Nov. 5, 2018 (EP) 18306449.2

(51) Int. Cl. H04N 19/105; H04N 19/132; H04N 19/583; H04N 19/176

(52) U.S. Cl. CPC H04N 19/105; H04N 19/176; H04N 19/583; H04N 19/132

(57) ABSTRACT

Different implementations are described, particularly implementations for video encoding and decoding using block extension for overlapped block motion compensation. The method comprises: obtaining for a current block of a picture to be encoded or decoded an extended portion corresponding to at least one portion of a neighboring block, the at least one portion being adjacent to the current block; forming an extended block using the current block and the extended portion; and performing a prediction to determine prediction samples for the extended block.

### TECHNICAL FIELD

The present disclosure is in the field of video compression. It aims at improving compression efficiency compared to existing video compression systems.

### BACKGROUND

For the compression of video data, block-shaped regions of the pictures are coded using inter-picture prediction to exploit temporal redundancy between different pictures of the video source signal or using intra-picture prediction to exploit spatial redundancy in a single picture of the source signal. For this purpose, depending on the used compression standard, a variety of block sizes in the picture may be specified. The prediction residual may then be further compressed using a transform to remove correlation inside the residuals before it is quantized and finally even more compressed using entropy coding.

In the traditional block-based video compression standards such as HEVC, also known as recommendation ITU-T H.265, a picture is divided into so-called Coding Tree Units (CTUs), which are the basic units of coding, analogous to Macroblocks in earlier standards. A CTU usually comprises three Coding Tree Blocks, a block for luminance samples and two blocks for chrominance samples, and associated syntax elements. The Coding Tree Units can be further split into Coding Units (CUs), which are the smallest coding elements for the prediction type decision, i.e. whether to perform inter-picture or intra-picture prediction. Finally, the Coding Units can be further split into one or more Prediction Units (PUs) in order to improve the prediction efficiency.

Exactly one Motion Vector is assigned to a uni-predictional PU, and one pair of motion vectors for a bi-predictional PU in HEVC. This motion vector is used for motion compensated temporal prediction of the considered PU. Therefore, in HEVC, the motion model that links a predicted block and its reference block simply consists in a translation.

In the Joint Exploration Model (JEM), which extends the underlying HEVC framework by modifications of existing tools and by adding new coding tools, the separation of the CU, PU and TU (Transform Unit)) concepts is removed except in several special cases. In the JEM coding tree structure, a CU can have either a square or rectangular shape. A coding tree unit (CTU) is first partitioned by a quadtree structure, then the quadtree leaf nodes can be further partitioned by a multi-type tree structure. In JEM, a PU can contain sub-block motion (e.g. 4×4 square sub-block) using common parametric motion model (e.g. affine mode) or using stored temporal motion (e.g. ATMVP). Namely, a PU can contain a motion field (at sub-block level) extending the translational model in HEVC. Generally, a PU is the prediction unit for which, given a set of parameters (for example a single motion vector, or a pair of motion vectors, or an affine model), a prediction is computed. No further prediction parameters are given at a deeper level.

In the JEM, the motion compensation step is followed, for all Inter CUs regardless of their coding modes (e.g., sub-block based or not, etc.), by a process called Overlapped Block Motion Compensation (OBMC) that aims at attenuating the motion transitions between CUs, somehow like the deblocking filter with the blocking artifacts. But, depending on the CU coding mode (for example affine mode, ATMVP, translational mode), the OBMC method applied is not the same. Two distinct processes exist, one for CUs that are divided into smaller parts (affine, FRUC, . . . ), and one for the other CUs (entire ones).

As described above, OBMC aims at reducing blocking artifacts caused by the motion transitions between CUs and inside those which are divided into sub-blocks. In the state-of-the-art, the first step of the OBMC process consists in detecting the kind of CU to perform OBMC on, either on the block boundaries or also on the sub-blocks inside the block.

### SUMMARY

According to an aspect of the present disclosure, a method for encoding and/or decoding a block of a picture is disclosed. Such a method comprises obtaining for a current block of a picture to be encoded or decoded an extended portion corresponding to at least one portion of a neighboring block, the at least one portion being adjacent to the current block; forming an extended block using the current block and the extended portion; and performing a prediction to determine prediction samples for the extended block.

According to another aspect of the present disclosure, an apparatus for encoding and/or decoding a block of a picture is disclosed. Such an apparatus comprises one or more processors, wherein said one or more processors are configured to: obtain for a current block of a picture to be encoded or decoded an extended portion corresponding to at least one portion of a neighboring block, the at least one portion being adjacent to the current block; form an extended block using the current block and the extended portion; and perform a prediction to determine prediction samples for the extended block.

According to another aspect of the present disclosure, an apparatus for encoding and/or decoding a block of a picture is disclosed. Such an apparatus comprises: means for obtaining for a current block of a picture to be encoded or decoded an extended portion corresponding to at least one portion of a neighboring block, the at least one portion being adjacent to the current block; means for forming an extended block using the current block and the extended portion; and means for performing a prediction to determine prediction samples for the extended block.

The present disclosure also provides a computer program product including instructions, which, when executed by a computer, cause the computer to carry out the methods described.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

Additional features and advantages of the present disclosure will be made apparent from the following detailed description of illustrative embodiments which proceeds with reference to the accompanying figures

### BRIEF DESCRIPTION OF THE DRAWINGS

FIG. 1 illustrates a block diagram of an example of a generic video compression scheme.

FIG. 2 illustrates a block diagram of an example of a generic video decompression scheme.

FIG. 3 illustrates in a) some Coding Tree Units representing a compressed HEVC picture and in b) the division of a Coding Tree Unit into Coding Units, Prediction Units and Transform Units.

FIG. 4 illustrates a known OBMC principle overview.

FIG. 5 illustrates an example of a processing pipeline to build an inter-predicted block.

FIG. 6 illustrates a block extension for OBMC.

FIG. 7 illustrates a generic flowchart for a method according to an embodiment of the present disclosure.

FIG. 8 illustrates a current block with a flowchart of the proposed OBMC processing of the current block according to an embodiment of the present disclosure.

FIG. 9 illustrates a modified processing pipeline with buffered OBMC bands.

FIG. 10 illustrates buffered extension bands at the time of processing a CU within a CTU.

FIG. 11 illustrates a bi-prediction optical flow process for an enlarged block.

FIG. 12 illustrates an intra prediction process for an added band.

FIG. 13 illustrates a scheme where the process is only activated for CUs inside of a CTU.

FIG. 14 illustrates a block diagram of an example of a system in which various aspects of the exemplary embodiments may be implemented.

It should be understood that the drawings are for purposes of illustrating examples of various aspects and embodiments and are not necessarily the only possible configurations. Throughout the various figures, like reference designators refer to the same or similar features.

### DETAILED DESCRIPTION

For clarity of description, the following description will describe aspects with reference to embodiments involving video compression technology such as, for example, HEVC, JEM and/or H.266. However, the described aspects are applicable to other video processing technologies and standards.

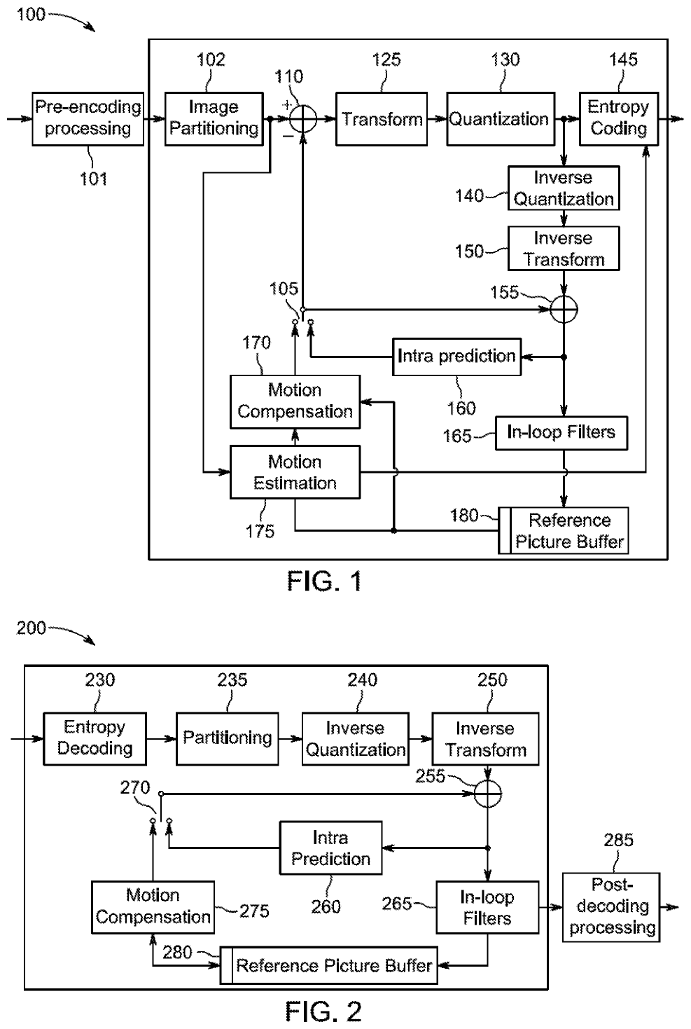

FIG. 1 illustrates an example video encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

To encode a video sequence with one or more pictures, a picture is partitioned (102), for example, into one or more slices where each slice can include one or more slice segments. In HEVC, a slice segment is organized into coding units, prediction units, and transform units. The HEVC specification distinguishes between “blocks” and “units,” where a “block” addresses a specific area in a sample array (e.g., luma, Y), and the “unit” includes the collocated blocks of all encoded color components (Y, Cb, Cr, or monochrome), syntax elements, and prediction data that are associated with the blocks (e.g., motion vectors).

In the encoder 100, a picture is encoded by the encoder elements as described below. The picture to be encoded is processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 2 illustrates a block diagram of a video decoder 200. In the decoder 200, a bitstream is decoded by the decoder elements as described below. Video decoder 200 generally performs a decoding pass reciprocal to the encoding pass as described in FIG. 1. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

FIG. 1 and FIG. 2 may illustrate an encoder and decoder, respectively, in which improvements are made to the HEVC standard or technologies similar to HEVC are employed.

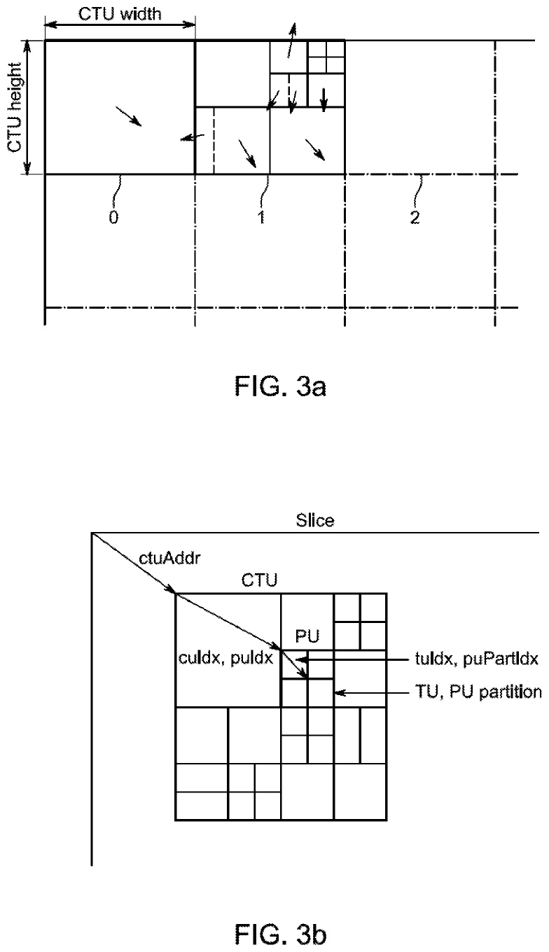

In the HEVC video compression standard, a picture is partitioned into coding tree blocks (CTB) of square shape with a configurable size (typically at 64×64, 128×128, or 256×256 pixels), and a consecutive set of coding tree blocks is grouped into a slice. A Coding Tree Unit (CTU) contains the CTBs of the encoded color components. An example for a partitioning of a part of a picture into CTUs 0, 1, 2 is shown in FIG. 3a. In the figure, the left CTU 0 is directly used as is while the CTU 1 to the right of it is partitioned into multiple smaller sections based on the signal characteristics of the picture region covered by the CTU. The arrows indicate the prediction motion vectors of the respective section.

A CTB is the root of a quadtree partitioning into Coding Blocks (CB), and a Coding Block may be partitioned into one or more Prediction Blocks (PB) and forms the root of a quadtree partitioning into Transform Blocks (TBs). A Transform Block (TB) larger than 4×4 is divided into 4×4 sub-blocks of quantized coefficients called Coefficient Groups (CG). Corresponding to the Coding Block, Prediction Block, and Transform Block, a Coding Unit (CU) includes the Prediction Units (PUs) and the tree-structured set of Transform Units (TUs), a PU includes the prediction information for all color components, and a TU includes residual coding syntax structure for each color component. The size of a CB, PB, and TB of the luma component applies to the corresponding CU, PU, and TU. An example for the division of a Coding Tree Unit into Coding Units, Prediction Units and Transform Units is shown in FIG. 3b.

In the following, for simplicity, it is assumed that CUs and PUs are identical. However, in case one CU has several PUs, the OBMC process described below can be applied for each PU independently or in raster scan order, one PU after another. Furthermore, the various embodiments presented below are applied to both sub-block PU (where the motion is not uniform inside the PU) and non-sub-block PU (where the motion is uniform inside the PU (e.g., HEVC PU)).

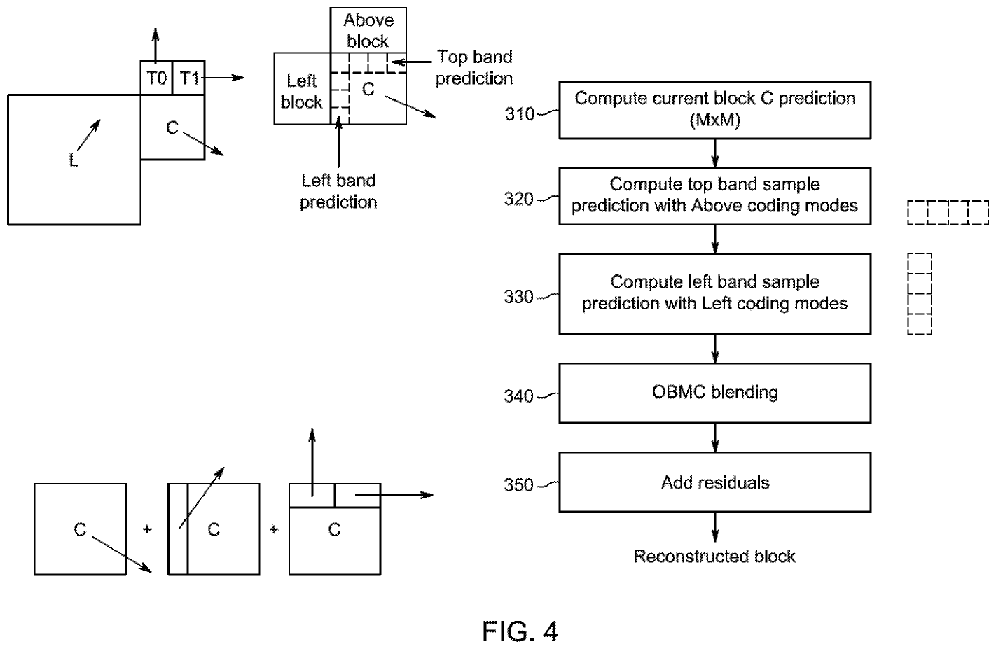

In FIG. 4 the principle of OBMC used in JEM is shown for a current block C with top block neighbors T0 and T1 and a left block neighbor L:
The current block C is first motion compensated (310) with the motion vector of the current block,
The top band of the current block C is motion compensated using the motion vectors of the above block neighbors T0 and T1 (320),
The left band of the current block C is motion compensated with the motion vector of the left block neighbor L (330),
A weighted sum (either at block level or pixel level) is then performed in order to compute the final motion compensated block prediction (340).
Finally, the residuals are added to the prediction samples to obtain the reconstructed samples (350) for the current block.

This OBMC process is performed for a particular block during the reconstruction of the block, which means that the parameters needed to perform the motion compensation of each band have to be saved in each neighboring block.

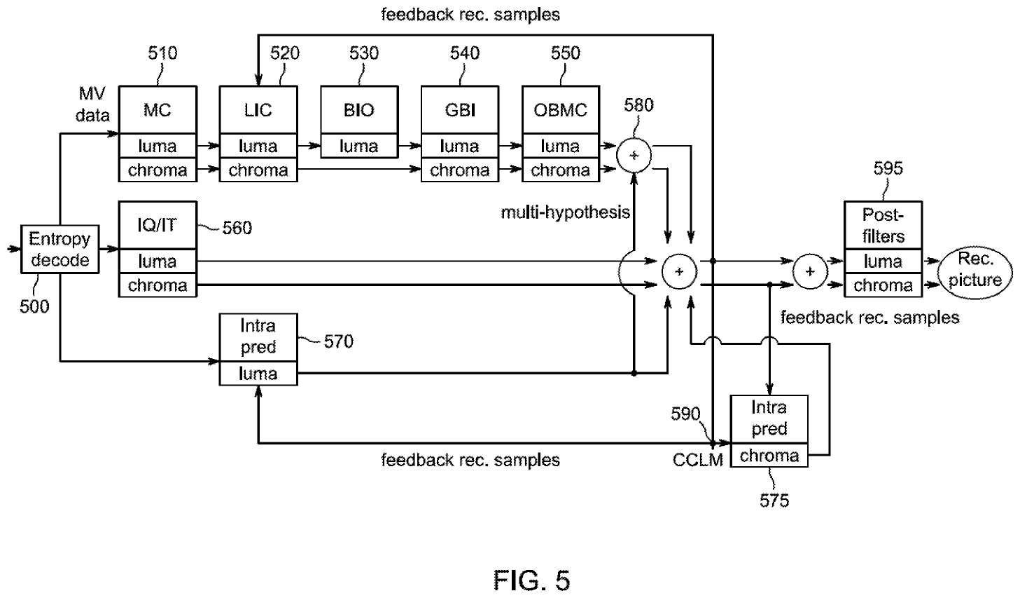

FIG. 5 shows an example of a processing pipeline to reconstruct a block in a JEM decoder using the known OBMC principle. Some of the stages may correspond to those shown in the decoder of FIG. 2, such as stage 500 for entropy decoding which may correspond to processing block 230 or stage 595 for postfiltering which may correspond to processing block 285. Furthermore, some of the stages can be bypassed.

Regarding the decoding of a predicted block, the following processes might be needed (see “Algorithm description for Versatile Video Coding and Test Model 2 (VTM 2)”, JVET-K1002, July 2018):
A stage 510 for motion compensation MC (either by block or sub-block).
A stage 520 for Local Illumination compensation LIC. In this stage the predicted samples values are changed using a linear adaptation for example.
A stage 530 for bi-prediction optical flow BIO. In this stage the predicted samples values are changed using the result of an optical flow estimation between the two reference blocks used to reconstruct the block. Another variant is decoder-side motion vector refinement (DMVR), not shown in FIG. 5.
A stage 540 for generalized bi-prediction GBI (a.k.a bi-prediction combination weighting, BCW). In this stage a weighted average of the two reference blocks is used to reconstruct the block.
A stage 550 for the overlapped block motion compensation OBMC. In this stage a weighted average of motion compensated blocks is calculated using different motion vectors from neighboring blocks as illustrated in FIG. 4.
A stage 560 for inverse quantization and transform IQ/IT to reconstruct a residual.
Stages 570 and 575 for Intra prediction to predict the luma and chroma components of a block using surrounding samples values.
A stage 580 for Multi-hypothesis (a.k.a. combination intra-inter prediction, CIIP), which merges together several predictions (typically inter and intra) using a weighted average depending on the prediction samples position and/or the coding modes of the neighboring blocks. Also a triangular multi-hypothesis can be used where several inter prediction can be merged inside a block.
A stage 590 for a Cross Components Linear Model CCLM which uses another already reconstructed component to predict the current component using a linear model.

As explained above, in JEM, the OBMC process was applied on the fly when reconstructing a particular PU. As some parameters are missing, or the computation is too expensive or infeasible when computing the motion compensated band, the motion compensated band is reconstructed using a simple motion compensation, without some other processes like LIC, BIO or multi-hypothesis.

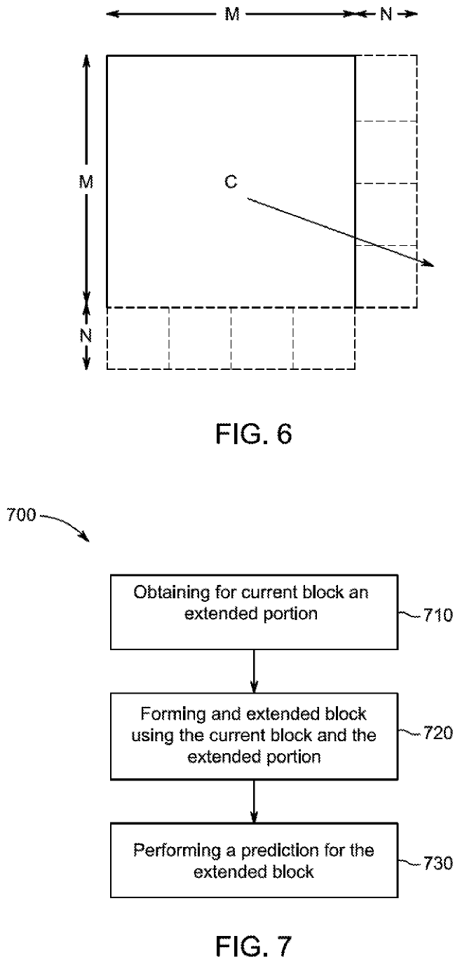

FIGS. 6, 7 and 8 show the basic principle of the proposed technique of the present disclosure. As illustrated in FIG. 6, for the block prediction of a particular current block C, the block is extended by a portion of additional samples on the bottom and right borders, to form an extended block. For example, the current block C may have a size of M×M samples and is extended by N samples on the bottom and right borders, to form an extended block having a size of (M+N)×(M+N)−1. A typically value is N=2 samples, but other values are also possible. In another example, the extended block has a size of (M+N)×(M+N). The decoder performs the prediction on the basis of the extended block.

FIG. 7 illustrates a corresponding generic flowchart for a method using this block extension. In step 710, for a current block of a picture an extended portion is obtained which corresponds to at least one portion of a neighboring block, the at least one portion being adjacent to the current block. An extended block is formed using the current block and the extended portion in step 720. Finally, a prediction is performed to determine prediction samples for the extended block, i.e. for both the current block and the extended portion.

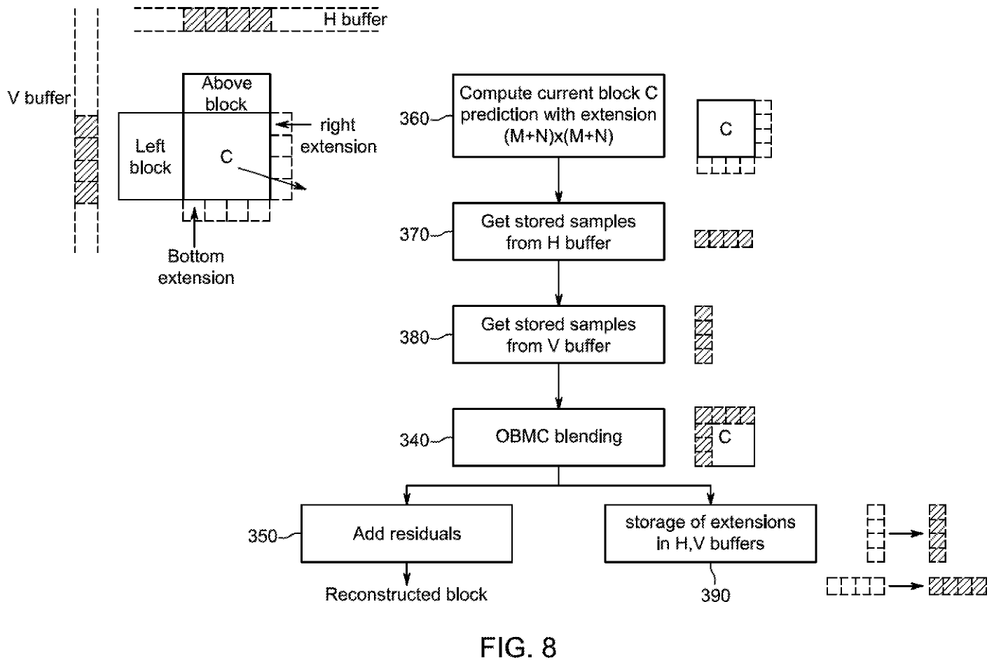

The computation of the block prediction according to the present disclosure is shown in more detail in FIG. 8. The left-hand side of the picture shows again the current block C with a right block extension and a bottom block extension. These extensions may be stored in a temporary buffer of size 2×N×M (represented in light-gray in (360)). These right block extensions and bottom block extensions are further stored in a schematically indicated H buffer and V buffer, respectively (390).

The extended block, i.e. the current block C and the block extensions are processed using the whole prediction construction in step 360 of the flowchart shown on the right-hand side. Note that the OBMC process for the current block does not have an impact on the added right and bottom borders of the current block.

For the OBMC stage of the prediction reconstruction, the stored samples in the H-buffer are read for top band weighting in step 370 and the stored samples in the V-buffer for left band weighting in step 380. Note that the top-left N×N corner is in both bands because it is used from both left and top for the corner sub-block of the current block.

Using the read samples and the prediction for the current block, a weighted average of the current prediction is calculated in step 340. However, no more on-the-fly temporal prediction is performed for the current block for OBMC, instead only a current block prediction process and an access to the band buffers is used. Without the need to access the reference picture buffer, as there is no on-the-fly temporal prediction, the memory bandwidth requirement may be reduced.

After the OBMC blending process, adding in step 350 the determined prediction and residuals values for this block allows to build the reconstructed samples as usual.

Finally, in step 390 the bottom and right extension bands are saved in a buffer for later usage. Advantageously, the buffer can be reduced to only two buffers (H, V) of size N×S_{H} and N×S_{W}×Width_{picture} respectively, where (S_{W},S_{H}) is the maximum size of a CTU (typically S_{W}=S_{H}=128) and Width_{picture} is the number of CTUs per row in one picture. In a variant, the buffer can be reduced to only two buffers of size N×S_{H} and N×S_{W} respectively if OBMC is disabled on top of the CTUs. In this step, the lines are saved into the H, V buffers for later use by the OBMC process of next CU. Furthermore, the CU size is restored to its original size before extension. Note that the V-buffer is a column buffer that will be furtherly called line buffer for simplicity and because the samples in the column buffer may be arranged into a line buffer and conversely.

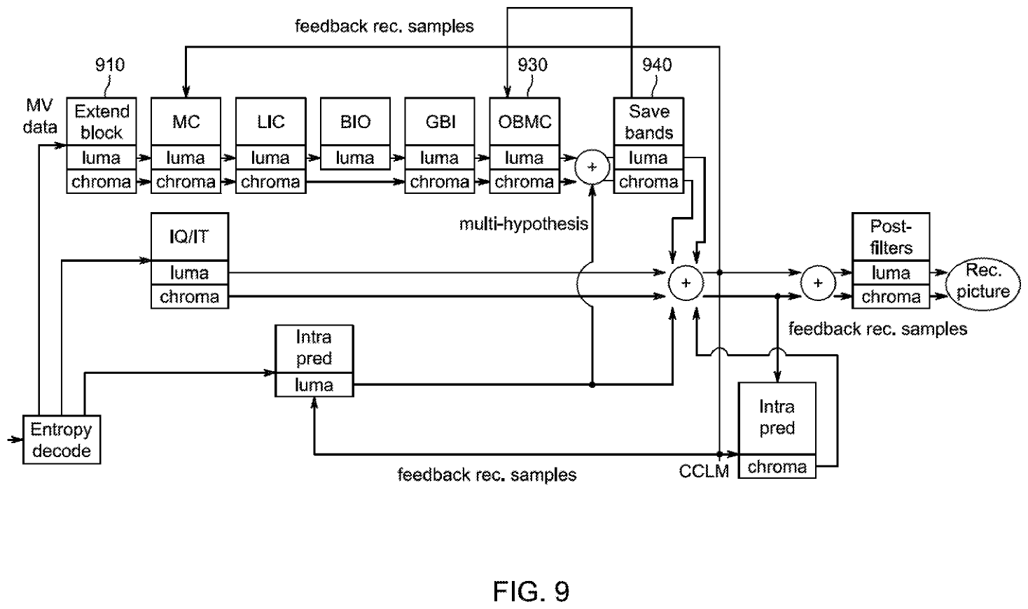

FIG. 9 illustrates a modified processing pipeline with buffered OBMC bands. Several of the processing steps remain unchanged as compared to the processing pipeline of FIG. 5 and, therefore, these processing steps are not discussed here again to avoid repetition.

At the beginning of the inter prediction processing, for the current block an extended block is built in processing block 910 as discussed above. The extended block is then processed using the whole prediction construction (including LIC, BIO etc.). Because different prediction methods such as LIC, BIO, and/or GBI are performed for the extension bands in the same manner as for the particular current block C, the mode information for different prediction processes are inherently kept in the predicted block, and there is now no need to store the parameters for performing OBMC for the blocks using these extension bands. It should be noted that some prediction methods such as LIC and BIO are not possible or not easy to be performed on just the extension bands, and therefore are skipped in the current JEM design. By extending the block, LIC and BIO can be performed in the extended block, covering these extension bands. Therefore, using the extended block can improve the prediction, by incorporating more prediction methods (e.g., LIC, BIO) in OBMC.

The OBMC process (930) for the current block is then performed as explained above in FIG. 8. As mentioned, this does not have an impact on the added right and bottom borders of the current block. The bottom and right bands are then saved (940) in a buffer for later usage.

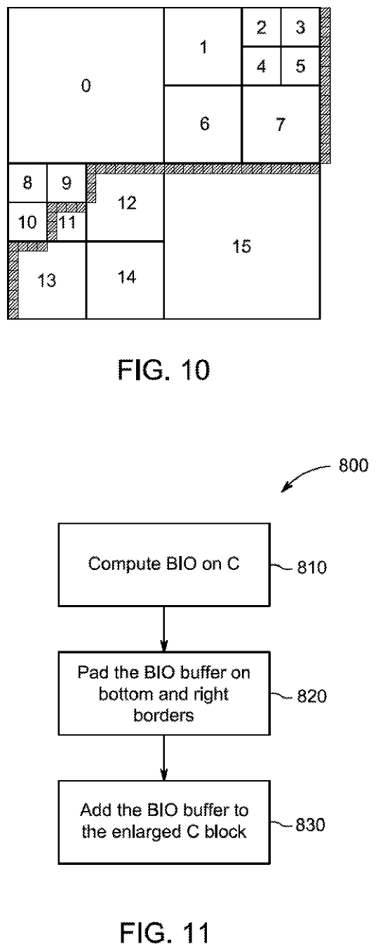

FIG. 10 illustrates the buffered extension bands at the time of processing a CU within a CTU. In this example, the CTU is split into 16 CUs 0 to 15, where the figure shows the buffer content when CU 11 is processed.

At the very beginning of processing this CTU, after the prediction of CU 0 has been computed, the bottom and right extensions of CU 0 were stored in the H- and V-buffer. However, during the processing of the following CUs, the right extension of CU 0 has been overridden by the right extensions of neighboring right CUs. Finally, for CUs 3, 5, and 7 there are no further neighboring right CUs in the same CTU, therefore, their right extensions remain in the buffer for the processing of the CTU neighboring to the right. Further stored right extensions shown in FIG. 10 are those of the already processed CUs 9 and 10 and for CU 13 a right extension from a CU in the CTU neighboring to the left of the current CTU. After the processing of CU 11 is finalized, the shown right extension of CU 10 will be overwritten in the buffer by the right extension of CU 11. Similarly, the buffered bottom extension of CU 0 has been partially overwritten by the bottom extension of CUs lying below, as well as those of CUs 1 to 5 and 8. After the processing of CU 11 is finalized, the shown below extension of CU 9 will be overwritten in the buffer by the below extension of CU 11.

In the case of sub-block motion vectors (arising in affine or ATMVP case for example), the same principle can apply. Two variants are possible:
The outside border of the CU follows the OBMC process presented here, using cached line buffer, while the inner boundaries inside sub-blocks follow the regular OBMC process (without caching).
Alternatively, the outside border of the CU follows the OBMC process presented here, using cached line buffer, while the inner boundaries follow a similar process (each sub-block is extended and the extensions are cached). The only difference is that the extension is on the four borders of the sub-block in this case (instead of the bottom and right only).

With the change in OBMC, other modules are adapted too, as described in further detail below.

Motion Compensation

Non-Sub-Block Mode

In regular mode (only one motion vector or a pair of motion vectors for the whole block), the motion compensation with a block extension is straightforward: the extended part undergoes the same motion compensation as the whole block.

Sub-Blocks Motion Extension

In the case of sub-block generated motion vectors (typically affine or ATMVP case), the extension of the block also requires the extension of the motion field. Two cases are possible:
For affine case it is always possible to compute the motion vector inside the extension using the affine motion model of the whole PU. Similarly, for ATMVP, when the motion vector inside the extended part are available in the temporal motion buffer at the translated position, these vectors are used.
For unavailable motion vectors in the extended parts, the motion vectors are just copied from the neighboring sub-blocks inside the PU.

In another embodiment, the second case is always applied whatever the availability of the motion vectors in order to keep the process of motion vector derivation by sub-blocks the same.

Local Illumination Compensation

During the LIC stage, the same process as for the current block is applied on the bottom and right bands as it is a pixel wise process.

BIO

In case of bi-prediction, the goal of BIO is to refine motion for each sample assuming linear displacement in-between the two reference pictures and based on Hermite's interpolation of the optical flow (see “Bi-directional optical flow for future video codec,” A. Alshin and E. Alshina, 2016 Data Compression Conference).

The BIO process is adapted by simply extending the block size on the bottom and right border and the BIO process is applied to the extended block.

Alternatively, in order to speed up the BIO process, especially the block avoiding multiplication by non-power of 2, the BIO process is kept the same, but as shown in as in FIG. 11 after computing (810) the BIO on the current block C the resulting BIO buffer added (830) to the current extended block is padded (820). The BIO buffer contains the correction to apply on the current prediction, computed from the optical flow derived from the two reference blocks.

Alternatively, the BIO process is not applied on the added bands.

GBI (a.k.a. BCW)

The GBI (bi-prediction weighting) process is applied on the added bottom and right bands in order to improve the reconstructed prediction for the bottom and right blocks in OBMC mode. The same weights are applied on the added bands.

Multi-Hypothesis (a.k.a CIIP)/Triangular Merge

The multi-hypothesis process is done at the very end of the reconstruction process. For an enlarged block, the process is kept the same:
Each hypothesis is performed on an enlarged block (i.e., the extended block),
The two hypotheses are merged together to form the final enlarged block.

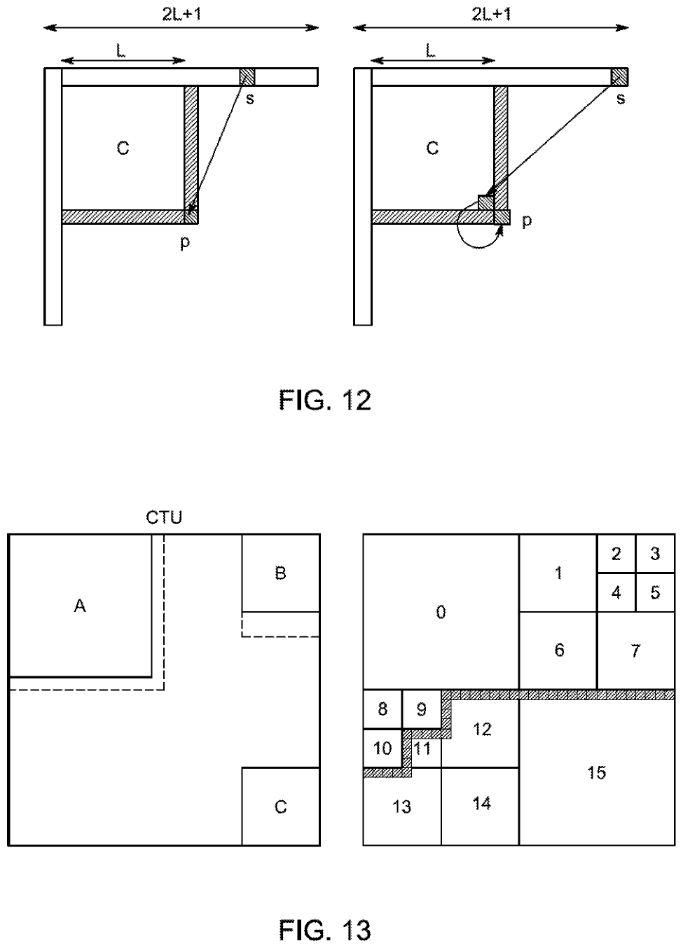

Some adaptations are done when computing the hypothesis:
For an intra hypothesis, the intra prediction in the added band is simply the padding of the intra prediction on the border of the PU. It means that the intra prediction is computed as if the PU size was remained unchanged.
In a variant, the intra prediction process is adapted to an enlarged block size as illustrated in FIG. 12. Two cases can arise: in the first one shown in the left part of the figure, the intra prediction angle is such as it requires access to reference samples already available in the reference samples buffer. In this case, the usual intra prediction process applies to reconstruct the pixel in the added bands (reconstruction process can be PDPC, Wide Angle Intra prediction etc., more information is available in JVET-G1001 (see J. Chen, E. Alshina, G. J. Sullivan, J.-R. Ohm, J. Boyce, “Algorithm Description of Joint Exploration Test Model 7 (JEM 7)”. In JVET document JVET-G1001) and JVET-K1002 (see “Algorithm description for Versatile Video Coding and Test Model 2 (VTM 2)”, JVET-K1002)). In the second case shown in the right part of the figure, when the reference sample is not available in the reference samples buffer, the pixels in the added bands are reconstructed by duplicating the pixels of the border of the block C in the extended band.

Precision Improvement

When building the pixels of the added bands, the highest precision is kept in order to improve the weighted average of the OBMC process, and therefore improve the compression efficiency. For example, in GBI mode or multi-hypothesis mode the prediction is computed as:

P_{gbi}=(αP₀+(β−α)P₁)//β (eq-1)

where P₀ and P₁ are the first and second prediction or hypothesis and β is usually a power of 2 to avoid an integer division. To keep the highest precision, the final normalization by β is removed for the added bands and transferred to the OBMC process. The prediction in the added bands is transformed as:

P_{gbi}=(αP₀+(β−α)P₁)

Then the OBMC blending process is given by:

P_{obmc}=(γP_{current}+(δ−γ)P_{neighbor})/δ
where P_{current} and P_{neighbor} are the predicted block using current block prediction parameters and the prediction coming from the neighboring prediction parameters (here accessed in the added bands). Assuming a GBI mode on the neighbor, the OBMC prediction is then transformed as:

P_{obmc}=(γβP_{current}+(δ−γ)(αP₀+(β−α)P₁))/(δβ) (eq-2)

where the β normalization is applied at the same time as the δ normalization of the OBMC process. Note that here we assume that P_{current} is the prediction of the current block (already containing an average of P₀ and P₁ if the block is bi-predicted). The P₀ and P₁ here are related to the modes of the neighbor.

The same principle can be applied to regular bi-prediction, triangular merge mode, multi-hypothesis or LIC normalization.

For example, in regular bi-prediction mode, α=1 and β=2, it gives:

P_{obmc}=(2γP_{current}+(δ−γ)(P₀+P₁))/(2δ)

In a variant, the final normalization by β is partially removed (β replaced by β₁, where β₁<β in eq-1 and β replaced by (β−β₁) in denominator of eq-2) so that high precision is kept while numerical temporary buffer storage remains below acceptable value (e.g. 32-bits or 64-bits or 128-bits).

Dependency Reduction

In one embodiment, to reduce the dependency between CTUs, the described process can be only activated for CUs inside a CTU, i.e. the band is not added when the band is outside the CTU. In the example shown in the left part of FIG. 13, CU A uses the described process, CU B uses the process only for the bottom band, and CU C does not use the process.

For CUs on the top and/or left borders of the CTU, since top and/or left extended bands are not available, OBMC is not applied. For the shown example, in FIG. 13, CU A does not use OBMC for its top and left borders, CU B uses OBMC only for its left border, and CU C uses OBMC for both its top and left borders.

For this embodiment, the right part of FIG. 13 shows, like FIG. 10, the buffered extension bands at the time of processing CU 11. For CU borders in between the CTU, the stored extensions are the same. However, since no bands outside the CTU are added, for CUs 3, 5, and 7 no right extensions are stored in the buffer. Similarly, CU 13 has no right extension from a CU in the CTU neighboring to the left of the current CTU.

Optionally, when an extended band is not available, the corresponding border of the CU can use the state-of-the-art OBMC.

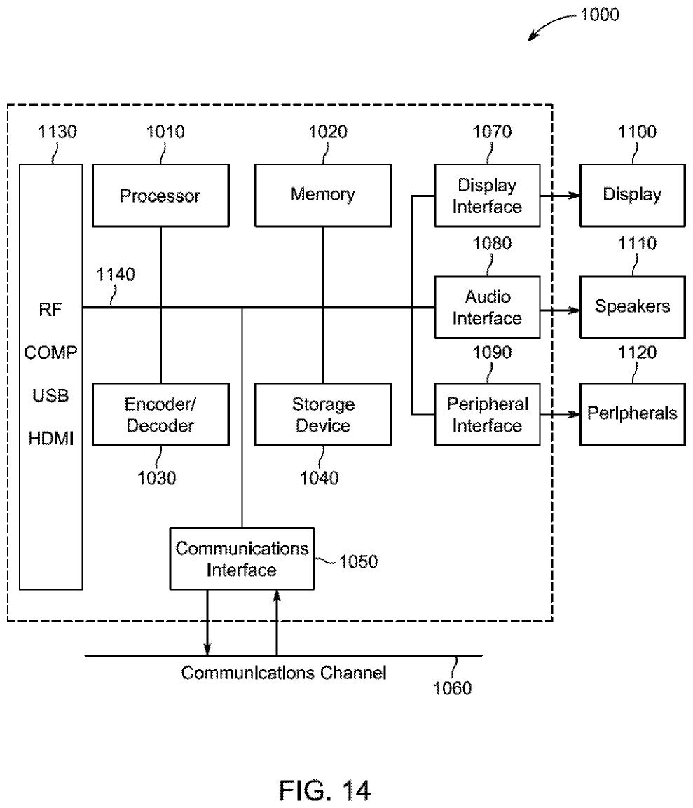

FIG. 14 illustrates a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 14, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other devices. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

This application describes a variety of aspects, including tools, features, embodiments, models, approaches, etc. Many of these aspects are described with specificity and, at least to show the individual characteristics, are often described in a manner that may sound limiting.

However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. FIGS. 1, 2, 9 and 14 provide some embodiments, but other embodiments are contemplated and the discussion of FIGS. 1, 2, 9 and 14 does not limit the breadth of the implementations. At least one of the aspects generally relates to video encoding and decoding, and at least one other aspect generally relates to transmitting a bitstream generated or encoded.

These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this application can be used to modify modules, for example, the motion compensation modules (170, 175), of a video encoder 100 and decoder 200 as shown in FIG. 1 and FIG. 2. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application, for example, the length of the extended portion. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1. A method, comprising:
obtaining for a current block of a picture to be encoded or decoded an extended portion corresponding to at least one portion of a neighboring block, the at least one portion being adjacent to the current block;
forming an extended block using the current block and the extended portion; and
performing a prediction to determine prediction samples for the extended block, wherein the prediction includes motion compensated prediction and other further prediction steps.

2. (canceled)

3. The method of claim 1, further comprising
storing determined prediction samples for the extended portion in one or more buffer memories.

4. The method of claim 1, wherein performing the prediction for the extended block comprises a motion compensated prediction, based on motion information for the current block.

5. The method of claim 4, further comprising:
obtaining from the one or more buffers stored prediction samples of an extended portion of at least one previously processed block of the picture; and
performing an overlapped block motion compensation for the current block based on the prediction samples of the current block and the stored prediction samples of the extended portion of the at least one previously processed block.

6. The method of claim 5, wherein after performing the overlapped block motion compensation for the current block, the stored prediction samples of the extended portion of the at least one previously processed block are overwritten in the one or more buffers by prediction samples of the extended portion of the current block.

7. The method of claim 5, wherein the extended portion corresponds to one or both of a bottom extension and a right extension, the bottom extension corresponding to an upper portion of a below neighboring block, and the right extension corresponding to a left portion of a right neighboring block.

8. The method of claim 7, wherein performing the overlapped block motion compensation comprises obtaining a weighted average of the motion compensated prediction samples of the current block and the stored prediction samples of one or both of a bottom extension of a previously processed upper neighboring block and a right extension of a previously processed left neighboring block.

9. The method of claim 7, wherein performing the overlapped block motion compensation for the extended block is based on the parameters for the current block.

10. The method of claim 1, wherein the one or more further prediction steps are at least one of a local illumination compensation, a bi-prediction optical flow, and a generalized bi-prediction.

11. The method of claim 5, wherein for the extended portion of the current block a normalization of intermediate prediction samples is not applied during the one or more further prediction steps but during the overlapped block motion compensation.

12-16. (canceled)

17. An apparatus, comprising at least one memory and one or more processors coupled to said at least one memory, wherein said one or more processors are configured to:
obtain for a current block of a picture to be encoded or decoded an extended portion corresponding to at least one portion of a neighboring block, the at least one portion being adjacent to the current block;
form an extended block using the current block and the extended portion; and
perform a prediction to determine prediction samples for the extended block, wherein said one or more processor are configured to perform the prediction by performing motion compensated prediction and other further prediction steps.

18. The apparatus of claim 17, wherein said one or more processors are further configured to store determined prediction samples for the extended portion in one or more buffer memories.

19. The apparatus of claim 17, wherein performing the prediction for the extended block comprises a motion compensated prediction, based on motion information for the current block.

20. The apparatus of claim 19, wherein said one or more processors are further configured to:
obtain from one or more buffers stored prediction samples of an extended portion of at least one previously processed block of the picture; and
perform an overlapped block motion compensation for the current block based on the prediction samples of the current block and the stored prediction samples of the extended portion of the at least one previously processed block.

21. The apparatus of claim 20, wherein after performing the overlapped block motion compensation for the current block, the stored prediction samples of the extended portion of the at least one previously processed block are overwritten in the one or more buffers by prediction samples of the extended portion of the current block.

22. The apparatus of claim 17, wherein the extended portion corresponds to one or both of a bottom extension and a right extension, the bottom extension corresponding to an upper portion of a below neighboring block, and the right extension corresponding to a left portion of a right neighboring block.

23. The apparatus of claim 22, wherein performing the overlapped block motion compensation comprises obtaining a weighted average of the motion compensated prediction samples of the current block and the stored prediction samples of one or both of a bottom extension of a previously processed upper neighboring block and a right extension of a previously processed left neighboring block.

24. The apparatus of claim 22, wherein the overlapped block motion compensation for the extended block is performed based on the parameters for the current block.

25. The apparatus of claim 17, wherein the one or more further prediction steps are at least one of a local illumination compensation, a bi-prediction optical flow, and a generalized bi-prediction.

26. The apparatus of claim 20, wherein for the extended portion of the current block a normalization of intermediate prediction samples is not applied during the one or more further prediction steps but during the overlapped block motion compensation.
